(19) United States
(12) Patent Application Publication
(10) Pub. No.: US 2007/0027746 A1
(43) Pub. Date: Feb. 1, 2007

(54) Method and system for online sales information exchange

(76) Inventor: George Adrian Grabowich, Flemington, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/496,147

(22) Filed: Jul. 31, 2006

Related U.S. Application Data
(60) Provisional application No. 60/704,304, filed on Aug. 1, 2005.

(51) Int. Cl. G06F 17/30

(52) U.S. Cl. 705/10

(57) ABSTRACT

An online sales lead exchange system is provided. Members of the system provide leads that can be obtained by other members. Leads are given ratings based upon the status of the depositing member and based upon the evaluations of other members. Members are able to increase their status within the system based upon the quality of their leads and their activity within the system.

This application claims priority to U.S. Provisional Application No. 60/704,304 filed on Aug. 1, 2005.

### BACKGROUND OF THE INVENTION

1. Field of Invention

The present invention relates to a system and method for tracking and exchanging sales information. In particular this invention relates to the exchange of sales leads via the Internet.

2. Description of the Related Technology

In the past, there have been generally a few different methods to attempt to track and improve sales efficiency. Some of these methods are company sponsored efforts, involvement in local organizations, personal marketing and joining web based communities.

Most efforts to improve sales efficiency are initiated by companies as part of their training, sales management and marketing efforts. This may be referred to as a vertical approach. Each company has slightly different methodologies on how to train, manage and secure leads for their salesforce. This may include the deployment of and use of a Customer Relationship Management (CRM) system such as Siebel™ CRM, PeopleSoft EnterpriseOne™, Salesforce.com, Microsoft™ CRM, etc. Each of these CRM systems may be either application service provider based (ASP) or sold as an enterprise based deployment model as software.

Typically, the CRM system is managed by the company and is designed for the company's benefit. These CRM systems act as repositories for all of the leads entered by the sales or marketing department for only that specific company. Lead disposition is managed by the sales or marketing employee as they go through the typical sales or marketing cycles. Often leads put into the CRM system stay in the system and are the property of the company that deployed the CRM system. These systems are used to manage the sales process and to communicate to management within the company the sales funnel to better predict revenue generation. It is also used to maintain contact with the prospect or customer over time in order maximize positive communications and reap the reward of the marketing dollars spent securing that potential customer.

Companies may also invest in the training of their sales people to improve their sales listening, sales probing and sales closing skills via programs such as Wilson Learning^{SM} or Miller Heiman^{SM}. These programs may improve the sales skills (and presumably sales efficiency of the sales person), but they do not help drive quality sales leads to the sales person to make them even more productive. Historically, marketing departments have used a mix of marketing media to generate leads. These include trade shows, list selections, direct mail, email, advertising and public relations. All too often the leads are largely disappointing as they relate to sales as there is little or no deep sales knowledge associated with the lead information which would assist the effort to improve overall sales efficiency. Additionally, these CRM systems typically do not track personal sales leads which include important information about the lead's decision maker, their buying authority level, the procurement process and other key information that facilitates sales expediency. In most CRM systems, personal sales leads from the salesperson are never entered into the system and are therefore considered “off the grid.” These salesperson sourced leads typically are not sourced from the company sales efforts and are therefore not the property of the company, unknown by them and unregulated by them.

Each community benefits when business is able to work efficiently. In order to insure local businesses operate at peak efficiency, organizations such as Kiwanis Club, Rotary International and local Chambers of Commerce, etc. have been formed so local business people can meet, exchange ideas and discuss business. These organizations are often effective but their reach is typically geographically limited and centered on small local businesses rather than larger businesses which may be regional, national or global in scope. These organizations provide forums for business people to meet as well as to provide political clout so local politicians do not take actions that are “anti-business”.

Furthermore, sales people have no trouble finding a large community of vendors selling seminars, books, tapes and CD's/DVD's on how to improve themselves as salespeople. Many ideas are well established and work but they all rely upon a salesperson to recognize they need to improve themselves and that they need to make the first step to buy a product or service to begin the improvement process. Salespeople sometimes purchase these on their own but their company efforts typically provide adequate resources as part of their training program. Sales people looking for an extra edge or that work in smaller companies where sales training is cost prohibitive will typically take on these types of services. These services do not generate leads but they do assist in making better salespeople by changing their daily practices.

Internet community organizations are relatively new to sales people and vary greatly in what they offer to improve sales efficiency. Some communities like Ryze (www.ryze.com) are general business networking sites that also include personal interest forums as well. Ryze allows people to set up communities within the Ryze community and allows people to “chat” and discuss issues but lacks the structured dimension for true lead exchange.

Prior art solutions attempt to exchange leads, typically in a local, small scale, venue such as a meeting, conference or social mixer setting but they fail in several key ways, including, but not limited to, the fact that they do not attempt to add a quality factor to the leads, they do not align geographically with the territory assignments of most professional sales people and are typically too limited in geographic scope and scale to be of use, and they do not establish a “quid pro quo” of submitting a lead and getting a lead of comparable value in return or multiple leads of lower value if desired according to a preset schedule.

For example, www.linkedin.com is a place for general business networking but is not focused on salespeople nor does it have an active sales lead exchange program with ratings in it. It is more of a “degrees of separation” service that allows people to reach out to others to explore general business opportunities like hunting for jobs, proposing business arrangements, general chatting and catching up with old friends or former business colleagues.

Business Referral Exchange (www.brenet.co.uk) is a UK based web portal that focuses on business networking but relies upon meetings as a means for business discussions and lead exchange rather than harnessing the power of the web.

On the other extreme lies a company called Integration Consortium (www.integrationconsortium.org) which specializes in submitting and withdrawing leads only within the a specific vertical niche of systems integrator projects. This special interest organization rewards members for putting leads into the system by providing “finders fees” to submitters for leads that result in business. Integration Consortium charges all members an annual subscription price for participating. The organization is focused on assisting its member community to cooperate and thereby generate business within the vertical systems integrator niche only.

While it can be appreciated that all of the above models have certain advantages, it can be seen that the approaches presented have inherent limitations and disadvantages. All of the prior art approaches are either company initiated, local organization centric, self initiated or are Internet based but still rely upon standardized meetings and seminars to help salespeople meet and collaborate. It would therefore be desirable to make a system and method that is geared towards sales people directly and specifically, i.e. the horizontal approach. One of the key reasons for a more horizontal approach is that sales people that sell a particular item or service may know of follow-on sales for complimentary goods or services that are needed by the customer to provide a complete end-to-end solution that they cannot themselves supply all the individual pieces. For example, if a server salesman sells 40 servers to a company there may be complimentary and synergistic additional goods or services that are needed by the customer to deliver a complete solution that the salesman may not provide and be able to sell. Those additional goods or services could be software, cabling equipment, rack mount hardware, raised floor systems, heating ventilating and air-conditioning services (HVAC), telecommunications services, integration services, IT outsourcing services, etc. Therefore a salesperson that has been able to sell to a particular customer and got to know a customer's decision making team and process, is in an enviable position to know the list of complimentary add-on sales that other sales people could benefit from as well as the customer. All too often, the salesperson that made the sale does not monetize that information and the opportunity lapses.

Therefore there remains a need to provide an efficient and reliable method and system for providing sales leads for sales people.

### SUMMARY OF THE INVENTION

The instant invention provides an efficient and reliable method and system for providing sales leads for sales people.

In a first aspect of the invention an online sales lead information system is disclosed. The system has a database of lead information. The system also has a server operably connected to said database. The system further has a router operably connected to the server and a lead rating control engine configured to provide a rating to the lead information.

In a second aspect of the invention, a method of providing sales lead information is disclosed. The method involves providing to a database lead information, wherein the lead information is associated with a first member. The method also involves attributing a rating to the lead information and further providing the lead information to a second member.

In a third aspect of the invention an online sales lead information system is disclosed. The system includes means for storing lead information. The system also includes means for providing a rating of the lead information, wherein the rating of the lead information is based upon a status of a first member.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWING(S)

FIG. 1 is a diagram of the system architecture.

FIG. 2 is a diagram illustrating the components of the system architecture.

FIG. 3 is a flow chart illustrating the steps associated with leads during a transaction.

FIG. 4 illustrates the home page of the system.

FIG. 5 illustrates a page for entering information regarding a lead.

FIG. 6 illustrates an additional page used for entering information regarding a lead.

FIG. 7 illustrates an additional page used for entering information regarding a lead.

FIG. 8 illustrates the deposit page of the system when viewed by a member.

FIG. 9 illustrates a page showing a member's lead deposits.

FIG. 10 is a view of the page shown in FIG. 6 having information entered.

FIG. 11 is a view of a page that is masked when viewed by a third party prior to purchase to show the amount of information filled in and in what fields without revealing the contents.

FIG. 12 is view of a withdrawn lead having space to enter additional notes.

FIG. 13 is a view of withdrawn leads with their ratings.

FIG. 14 is a view of challenged lead ratings.

FIG. 15 is a logic diagram showing the lead withdrawal process.

### DETAILED DESCRIPTION OF THE INVENTION

The present invention adds standardization to a salespersons' leads and allows salespeople to deposit leads into a network and receive leads of comparable value back. This exchange system allows salespeople to be more productive on their own and independent of their company efforts. The method and system is scaleable so as to be a nationwide resource and provides value added services to salespeople to help them be more effective. A rating system may also be employed in the present invention to insure that the quality of leads and the reputation of the depositor of the lead is known to users before they withdraw a lead and spend their earned lead credits. This manifests itself in several ways by allowing a withdrawing member to see the rating on the lead and to research all of the ratings on the lead that the lead has received over time. The member can also research the depositing member's other leads and how they have performed over time as well as view the reverse inherited rating of the depositing member's rating over time. In this way a withdrawing member has a peer established “on-line” reputation history to assist them in their “buying” decision. This self policing capability is one of the important features of the present invention's and the networking service it provides to its members.

In a preferred embodiment of the present invention salespeople are the people who submit and extract leads, not the company's that employ them. Although it should be understood that it is possible for the system and method to be employed by larger organizations. Thus the present invention is intended to capture, store and share “off the grid” sales leads that the salesperson does not typically share with their company. The reason why a salesperson would not share them with their company is that they fear having a lead re-assigned to another salesperson as territory boundaries often shift. As a result, they keep these leads to themselves and access them when needed and appropriate. However, it may be possible to expand the method and system to incorporate the sales force in small to large businesses, as well as to salespeople that sell business-to-business (B2B) or business-to-consumer (B2C). It is also intended that the method and system will be used on the local, regional, national and international levels.

This method and system is designed to track and improve the effectiveness and efficiency of sales people by providing them with a standardized Internet based platform and virtual community where they may store their own personal sales lead information as well as voluntarily exchange sales leads and pertinent detailed deep sales process information and knowledge with other sales people which sell complimentary goods and services, thereby increasing overall sales efficiency. Leads may be stored privately and be unavailable for others to view, similar to a bank repository service, or they may be submitted into the exchange network by a member of the community, similar to a trading floor service. Usage of the trading floor model entitles members to a number of lead withdrawals of comparable quality as well as “lead interest” earned. Lead interest is provided when a lead is shared with others. This sharing of leads is tracked by the system and additional lead credits are given to the depositor of the lead over time for each withdrawal of a lead by other members.

In a preferred embodiment, leads are ranked by other members who use them. They are ranked based upon the correctness and completeness of information submitted and not if the lead turned into a sale or not. This rating accumulates on the lead as it is used by multiple people and the average rating score is visible to others contemplating the use of that lead. The lead ranking also accumulates on the original lead submitter which adds to their overall ranking as a member. This buyer/seller style peer ranking system is the heart of the community and lets members who provide correct and complete information to rise in the system thereby allowing them to enjoy the increased benefits of membership while those members who provide incorrect or incomplete information are soon culled from the system and have limited benefits. Rating the correctness and completeness of a lead establishes one of the dimensions ultimately measured by the system for a member. This dimension captures the trustworthiness of a member and reflects his or her ability to supply solid, truthful and comprehensive information about a sales opportunity. Some other dimensions include salesmanship and the ability to collaborate. The salesmanship is measured based upon actual customer feedback about a member's sales process, interpersonal skills and closing capabilities. The ability to collaborate is measured based on a member's participation in the rating process as well as their offering to assist working with other member's in sales syndicates to sell complete end-to-end solutions together as a selling block. In this way, the invention measures a peer based view of important qualities of a salesperson and high ranked members are subsequently rewarded.

Leads can be selected based on a variety of criteria such as lead geography, industry of the lead, previous sale dollar value, etc. As leads are shared, the sales process becomes more open and more efficient. The method and system taps “off the grid” leads and acts to make them more valuable to the sales person by getting multiples of their value via a structured and formalized virtual trading floor.

The members of the system are involved in self policing the quality of its members based on the quality of their leads. This rating structure rewards those sales people who have credible information and provide beneficial and/or rewarding leads. Membership benefits change based on a sales person's rating with highly rated sales people obtaining the maximum benefits of membership and low rated salespeople being limited in their benefits. Perpetually low rated sales people will either voluntarily leave the system or will be asked to leave if violations of established rules occur more than a certain number of times.

Active involvement has its rewards by stratifying the salespeople into their own natural layers and making that rating visible allows members to know more about the type of sales people they are dealing with and will be potentially procuring leads from.

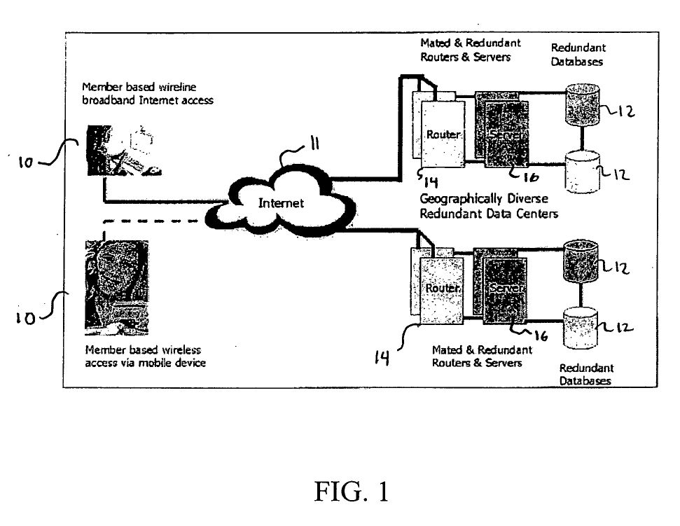

FIG. 1 illustrates a general overview of the system used in the instant invention. Members 10 connect, either wirelessly or via established wire line networks, through Internet 11 to routers 14, servers 16, and databases 12. Routers 14, servers 16 and databases 12 may be geographically diverse, mated and redundant. Servers 16 typically comprise a computer or computers having one or more processors that deliver information and software to other computers on a network. Router 14 is typically a device or setup of hardware components that attempts to find the best route between any two networks, even if there are several networks to traverse. Remote sites can be connected using routers 16 over dedicated or switched lines to create wide area networks (WANs). Database 12 may comprises a collection of information stored in a computer in a systematic way, such that a computer program can consult it to pull information together to answer member questions. The software used to manage and query a database is known as a database management system (DBMS). The stored information may be placed on any type of storage device known in the art. Database 12 is used in the system to store information related to members 10 and sales leads.

Since salespeople are often on the road doing their jobs and therefore mobile, the present invention allows access to information from either a PC/laptop or mobile device such as a phone, smart phone or PDA/EDA. This provides members 10 with access to new leads when out on the road when they are likely to need that information the most.

The instant invention standardizes the sales process and sales information in addition to rating members 10 themselves. The present invention provides a standardized format of sales lead information that can be easily imported or exported from other contact management packages like Microsoft Outlook™, Act™, Goldmine™, Siebel™, and Salesforce.com™, etc. Once in a common format and with appropriate application programming interfaces (APIs), the present invention provides a universal database 12 to allow the easy exchange of information between various management systems if desired. The ratings for leads and the accumulated multi-dimensional rating score for members is also in effect a standardized rating score for salespeople. This can be used to provide potential employers with a standardized way to view potential employees before they are hired. “Visitor Passes” issued by members 10 to their potential employers would allow the company to look into the sales person's history without revealing lead or account details. This allows a potential employer to see what the sales person has done and could potentially “bring to the table” should they be hired.

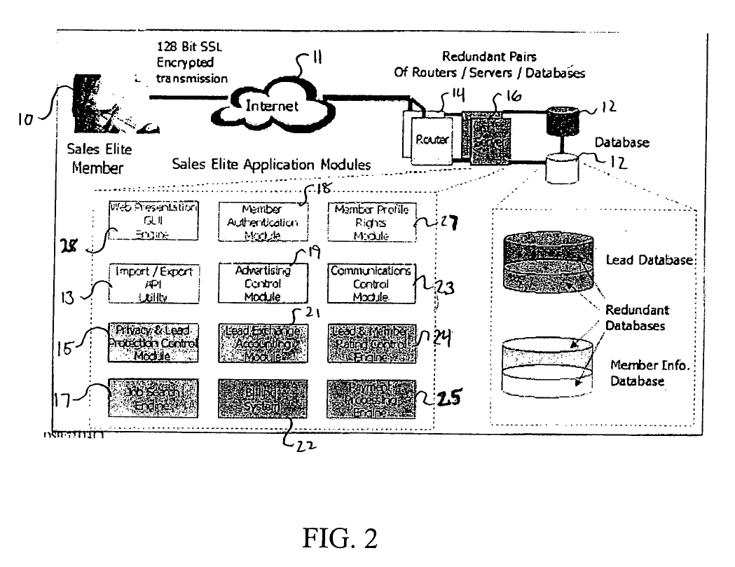

The present invention generally targets members 10 that are professional salespeople. Members 10 deposit their personal “off the grid” sales leads into the virtual bank vault for safe keeping. All leads may be imported using Import/Export API Utility 13, shown in FIG. 2, or they may be input manually by members 10 into this repository. Import/Export API Utility 13 will allow selected automatic extraction and insertion of contact information into the present invention from other standard sources such as Microsoft Outlook™, Act™, Goldmine™ or other personal contact management software. Once in this repository, only member 10 has access to these leads. This repository service may be free to all members 10 and no subscription fee may be charged to people only taking advantage of this “repository” service. A minor subscription fee may be introduced over time for this initially “free” feature. This is used to gain subscribership, word of mouth buzz and to establish the brand.

A “lead” may be made up of several data subs-elements including its relevant vertical industry, relevant functional area, production area, service area, company name, contact information; including addresses, title of contact, phone information, and email information; and business and key interpersonal information that may be used to assist in relationship building with the key decision makers and influencers in the business process. The lead may also contain a particular customer need, immediacy details about when the need must be fulfilled by, key information necessary to close business with this company as well as a description of the good or procurement process at the company. The “lead” and its associated contacts are coupled and tailored to a specific sales opportunity. This makes the sales leads far more important and salient to the overall sales process.

Members 10 can voluntarily choose to put their leads to work for them by sharing their leads with other members 10 in the virtual community. This trading floor option may cost a monthly subscription fee. A submitting member 10 may submit one lead into the networking pool that entitles them to one lead withdrawal of comparable value of multiple leads of lower rating value or any combination of equal or lower value leads.

Lead value is established based on ratings from other members 10 that have used the lead and can substantiate the leads integrity or veracity. New members 10 enter the system with a neutral rating on themselves and any leads they initially submit as part of the trading floor option. It is initially contemplated that each person turning on this optional feature must enter a minimum number of leads to enter the program. The number of leads may be one or more, preferably more than one. Additional leads may be entered in individual lead increments thereafter. These leads all carry a neutral rating initially as they were submitted by a neutral rated member. As other members 10 exchange their leads for these initially neutral leads, these members 10 will rate the integrity of the information of the leads. If the information integrity is high, the lead will receive a good rating and will stick with that lead. These good ratings will carry back to the original submitter and help raise their member rating level on a community visible profile level. If all of the submitted leads are good and continue to be rated by other members 10 that way, the person's ratings will be good as well and will be reflected in a numerical score. “Good” ratings get 4 points, “neutral” ratings get 2 points and “bad” ratings get 1 point. It should be understood though that the scoring system may vary. For example, a numerical score may initially be provided, such as a number from 1-10, instead of a “good”, “neutral” or “bad” rating. A similar rating representation will be used when displaying the other dimensions of collaboration and salesmanship.

The lead may then display the total points accumulated divided by the number of times it has been accessed to reveal a simple average score for that lead. Measurement timeframes for computing the average may vary over time such that a person's rating is based upon a rolling six months initially but may change overtime. Each feedback left is visible to each person scoring the lead as well as the statistics of the number of times it was accessed, total score, etc. Lead scores also affect the personal rating of depositing member 10. In order to get a member rating, using the example scoring system provided above, all of the individual leads ratings for the leads of member 10 ever placed on the trade floor are multiplied by 2.5 to convert to the member based 1 to 10 ten point rating scale. All leads are then added together and divided by the total number of leads ever on the trade floor to get a 1 to 10 rating score. Leads that move onto and off of the trade floor are counted with them holding the last rating they had when on the trade floor. In this way the rating for member 10 is a representation not only of current status but of total status over time as well.

If salespeople submit invalid leads, which may be considered a rules violation, they will be rated poorly by others and the negative lead ratings will accumulate on the depositor's community visible profile rating. Fewer people will want to deal with these type of members 10 and they will eventually find it increasingly difficult to share and participate in the system. If rules violations occur and continue, membership of member 10 may be revoked.

In the example provided above, members 10 having “Good” ratings will want to maintain that rating as it will permit them access to other “Good” members 10 leads and business is likely to flourish. One “Good” lead entitles the depositor to 1 “Good” lead out, 2 “Neutral” rated leads or 4 “Bad” rated leads or any combination adding up to a total value of 4 sales lead credits. “Neutral” rated members 10 that deposit 1 lead have access to 1 “Neutral” rated lead in the pool or 2 “Bad” rated leads. “Neutral” rated members 10 do not have access to “Good” rated leads, they must earn the right to those leads. “Bad” rated members 10 who deposit 1 lead will only have access to 1 “Bad” rated lead in return. “Bad” rated people do not have access to “Neutral” or “Good” rated leads. Highly rated members 10 therefore have the most to gain from the system as they have the greatest latitude in using and benefiting from the system. “Neutral” or “Bad” rated leads are potentially riskier but if a low rated member 10 is trying to climb the ladder to become a “Good” rated person, their leads may be a worthwhile risk. Members 10 will be able to view other members lead activity on-line in a historical order and determine if they are showing any promise and act accordingly with that member 10 or their leads.

As trends become established the rating number will be a strong indicator of salesperson competency, behavior and efficiency. The higher the number, the stronger the likelihood that the salesperson is a top producer that any company would seek out and want to hire. The rating system, therefore, has the potential to numerically quantify the competency of a sales rep and may be used by businesses in hiring decisions. Salespeople can also opt to offer prospective employers a “visitor pass” to see the strength of their contact base as it is on the system of the present invention. This “visitor pass” would allow people to see basic lead info without revealing the companies name or other individual contact details in the sales lead. This also goes a long way towards establishing sales credibility and if sales people are really whom they claim to be.

As discussed above, the system and method is accessible from most PC's, and laptops via a standard browser or mobile devices via a microbrowser or the like. FIG. 2 is a diagram illustrating the various aspects of the system that employs the sales lead method.

FIG. 2 shows member 10 accessing database 12 through Internet 11. A 128 bit encrypted transmission is used in providing information so that there is little risk of an outside source accessing the secured information. Transmission security may be improved as the ability to provide secure transmissions increase with time. Transmissions are run through router 14 and server 16 in order to access database 12.

Database 12 may be part of an array of databases. The array of databases may include a lead database, member's information database, as well as redundant databases for information back-up.

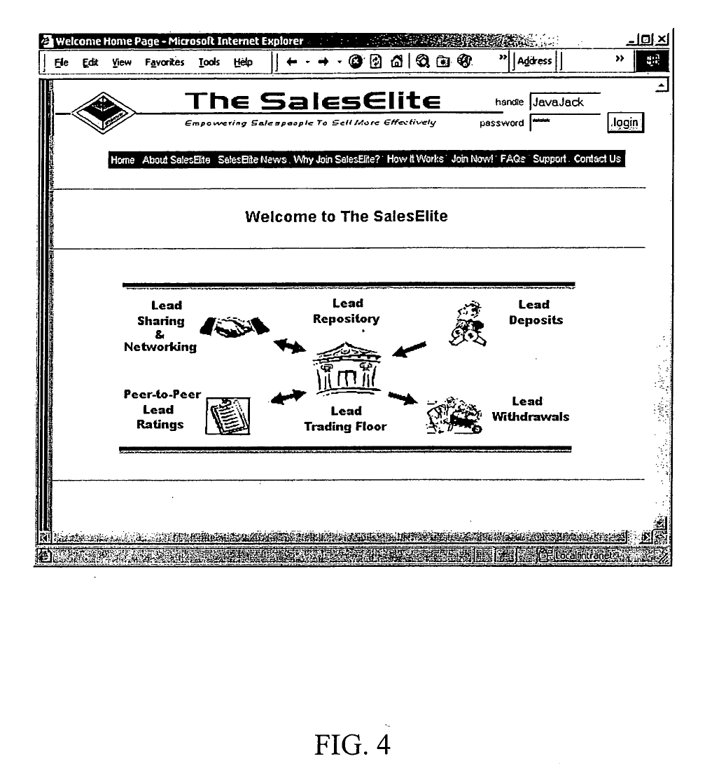

Server 16 provides the presentation of the pages through which people interact. These pages are a product of web presentation GUI (graphical user interface) engine 28. People enter the website of one embodiment of the present invention and are greeted by a page generated by web presentation GUI engine 28, such as the homepage shown in FIG. 4. The page may be generated in HTML for use by any personal computer or laptop with a common web browser (such as MS Internet Explorer™, Netscape™, Mozilla FireFox™, Safari™, etc.). An example of the generated pages can be seen in FIGS. 4-14. A WAP2 based alternative website will also be available to render graphically smaller web content that is better sized for cell phone, smart phone, PDA or EDA access via micro browsers such as Opera™, MS Pocket IE, Openwave™, Obigo™, Nokia™ Series 40/60 microbrowsers, and Netfront™. Web presentation GUI engine 28 will render either web page format based upon the web page accessed and the nature of the device requesting the data. On the homepage, people may see either a “log-in” area, if they are existing members, or they will see testimonials, advantages of membership, news etc. to get new visitors to want to become members.

On the site (both full VGA or WAP2 microbrowser based) the present invention may provide advertising and hyperlinks that will provide a variety of goods, services and products that are useful to those individuals who typically visit the site, such as salespeople. Web based advertising may be rendered by Web Presentation GUI Engine 28 and will be user device appropriate (for example an advertisement in HTML may be flash formatted). All advertising will be managed by Advertising Control Module 19 and it will control the activation of an advertisement, the suspension of an advertisement or deactivation of an advertisement on the web pages it is supposed to be put on and it will also send instructions to Billing System and Payment Processing Module 25 to bill advertisers for the use of the link. Measurements of “click throughs” will be kept by Advertising Control Module 19 so as to provide audit trail reports for either automated or manual billing (if needed) as well as for the advertising sales to quote click through statistics to potential advertisers.

Using Member Authentication Module 18, existing members 10 will log-in and be sent to their account associated web page where they can see the status of their leads, see lead trading status (if engaged) and have access to lead maintenance activities. Existing members 10 will be provided with a number of attempts to enter their log-in User ID and Password. If member 10 fails to enter the information correctly for the number of attempts, the account will be locked up and Communications Control Module 23 will send an email to the registered email address of member 10 informing him or her that his or her account may have been the target of an invalid log-in attempt. They will be provided with instructions as to how to unlock their account in the email. In the log-in area, there will be a “Forgot My User ID/Password” hyperlink that will allow members 10 to retrieve their User ID or Password upon answering a security question correctly. The User ID and or Password will be sent to the registered email address of member 10 by Communications Control Module 23.

On the home page, such as that shown in FIG. 4, prospective new members will see several promoted hyperlinks that will call the visitor to action to become a member. Upon clicking one of the hyperlinks, the non-member/visitor is sent to a new web page where they can sign up to become members. Visitors can become members 10 by filling out the member profile fields on the “New Member” webpage. This webpage feeds the visitor inputs into Member Authentication Module 18. Profile fields may be mandatory and should require standard contact information (name address, phone numbers, email addresses, etc.), credit card registration information for billing purposes and they will also need to create a member ID and a password. Security questions may also be required as well. Additional information may be requested so as to further form a more complete biography. Information such as what type of sales person they are, what they sell and to whom may be included in the pieces of information requested.

They may also enter information associated with their privacy settings, which will be relayed to the Privacy and Lead Protection Control Module 15. These privacy settings will manage how the identity of member 10 will be handled both within the repository and the trading floor virtual environments. All of these fields become part of the profile of member 10. The profile rights established in the Member Profile Rights Module 27 will allow them to access different services as member 10. The Member Profile Rights Module 27 will send credit card information daily to Billing System 22 and Payment Processing Engine 25 for all charges to be charged on that day.

Once the profile is submitted and the box stating that one agrees to abide by the rules of the system of the present invention they are given membership. After establishing membership in the system, members 10 can now enter leads manually or use the Import/Export API Utility 13 to import leads from standard contact applications like Microsoft Outlook™, Act™, Goldmine™, etc. The utility will allow member 10 to selectively pull just those contacts in their personal lead databases that they want to use to populate their secure lead repository. A legal disclaimer may resides on the bottom of the New Sales Lead form but may also at some point appear as a pop-up that warns the user not to submit leads that are the property of a current or former employer and request verification that the leads being entered are personal leads. Preferably members must actively check off that they are certifying the leads as personal leads and that member 10 will hold the company harmless from prosecution if leads entered are discovered to be the property of others. Each active check-off by member 10 certifying their leads as personal may be captured and entered into Member Profile Rights Module 27 and archived in database 12 along with the Lead Import Transaction ID for all leads imported during a session. This Transaction ID will follow the lead, member 10 and be tied to the acknowledgement for the duration of the subscription and the sales leads existence of member 10.

Leads are only accessible by member 10 at first. The system will act like a secure bank vault for them to be housed for safekeeping in a universal format. The management of the system may have backdoor access to the leads in the event customer service or other SalesElite company officials need to investigate member claims for violations or for law enforcement or other official government institutions subpoena access to a particular user for some official purpose. In addition, as part of the terms and conditions, an authorized SalesElite company user may summarize general information from all leads or within various categories for sale to analysts or consultants but will not reveal any one member's specific leads or the detail within them to any entity without the expressed permission of the lead owner.

Once member 10 has entered a lead into the repository, they may have the option to keep them there for free initially. At some point a minor subscription fee may be charged at a later time once critical mass has been reached or they may subscribe to the trading floor option for a monthly fee. The fee may be automatically charged to their registered credit card on a month-to-month basis unless member 10 decides to cancel the service. Members 10 may suspend the trading floor option at anytime. Whether or not a refund will be provided is optional. If member 10 decides to stop the trading floor option, all leads that were on the trading floor option will be immediately returned to the repository and become inaccessible by any other members 10. Anyone's leads exchanged and copied to the portfolio of a withdrawing member prior to the end of trading floor service are the property of those other members and are not returned to the original owner. Members 10 may elect a full year option where they pay a full year in advance and receive a discount. In return for annual subscriptions, the fee may be discounted approximately 10%.

Payments will be processed by Payment Processing Engine 25 and be recorded in Billing System 22 on a daily basis. Billing System 22 will communicate with Communications Control Module 23 in order to prompt member 10 with emails to re-subscribe at the end of their terms or provide them a receipt for the subscription fees charged monthly. Billing System 22 and Member Profile Rights System 27 will coordinate credit card anniversary dates and expiration dates and will send a message to Communications Control module 23 to send a member an email to renew their credit card information if the credit card expiration date is 60 or fewer days away. Upon the receipt of these notifications from Communications Control Module 23, member 10 will need to log-in to the system to update any information the system is requesting.

In order to trade leads on the virtual trade floor members 10 need to have their leads in the repository. Member 10 may enter the virtual trade floor only if they have elected this option, paid their initial monthly subscription fee in advance (and it was successfully processed by Payment Processing Engine 25 and a valid transaction ID was returned from the credit card clearing house. Furthermore, it is preferable that a certain number of leads have been provided by member 10, preferably at least ten leads should be entered into the trading floor. Grace periods may be introduced to new members waiving minimum sales lead requirements for a predetermined period of time. After the initial, submission of leads into the system, additional leads may be added one at a time or in larger blocks. The system may require that a minimum “account balance” of leads must be maintained at all times. If the trading account of member 10 falls below the lead minimum, a message may be sent to Communications Control Module 23 to send registered member 10 an email stating that their leads are below the minimum and that their trading privileges will be suspended unless they come into minimum lead balance compliance. A grace period may be provided before any service disruptions occur. E-mails may be sent periodically until either member 10 replenishes the account or member 10 will be sent a disconnection notice and their entire account may be suspended. Members 10 can re-enter the system and remove suspension status by paying a new monthly fee. A number of violations of this type may result in a permanent loss of membership.

An important feature of the lead trading system is the member rating structure. Leads entered into the trading floor for trading are subjected to a very simple rating system performed by other members 10 based upon the quality of the leads they have entered. Leads may be either “Good”, “Neutral” or “Bad” based on the status of the submitter. In the example provided each lead will have a credit value of 4 credits for a “Good” lead, 2 credits for a “Neutral” lead and 1 credit for a “Bad” lead. This credit value is used as a trading redemption number and is the “currency” used by Lead Exchange Accounting Module 21. This is slightly different than the points score used for determining a lead's rating. The provided leads get ratings from other members 10 rating their lead and results in a credits issued/debited to account for the lead transaction and also re-attributes a rating score on a lead used for posting and viewing purposes by members 10.

For example, if a particular lead is deposited by Mr. Smith, and Mr. Smith is a new member 10, he has an unknown status and is therefore rated as a “Neutral” member (initial rating of 5.0) with no established reputation yet and Mr. Smith's lead submissions are all considered “Neutral” as well. Initial lead submissions acquire the rating of their depositor. That snapshot rating stays on the lead until such time as other members 10 begin to independently rate the quality of the lead, either raising it to “Good”, dropping it as “Bad” or remaining “Neutral” if the lead has some questionable quality to it.

In Mr. Smith's initial deposit of required leads, ten in this example, Mr. Smith will have earned 20 lead credits (2 credits for each “Neutral” rated lead times ten leads). These 20 lead credits allow Mr. Smith to buy other sales leads on the trade floor. Mr. Smith though can only access other leads rated the same as his rating or below. In other words, he can only view other “Neutral” or “Bad” rated leads and cannot see nor redeem his credits for any “Good” rated leads. In the provided example, he will not yet have visibility into the system to see “Good” leads as he has not yet earned that privilege. Therefore Mr. Smith can buy 20 “Bad” leads which are potentially risky propositions or withdraw 10 other “Neutral” leads or any combination of the two (such as 8 “Neutral” leads and 4 “Bad” leads for a total of 20 credits used). If Mr. Smith put in poor quality leads and had a bad personal rating, Mr. Smith would only be able to see other bad rated people's leads and use his ten credits (10 “Bad” leads times 1 credit per “Bad” rated lead) to buy other “Bad” leads. On the other hand, if Mr. Smith was rated “Good”, he would have 40 credits (10 “Good” rated leads times 4 credits per lead) and enjoy visibility to other “Good” rated peoples leads as well as “Neutral” and “Bad” rated peoples leads. Clearly, “Good” rated people have the greatest visibility, numbers of credits and access to the greatest number of leads. A member 10 benefits from being rated “Good” in the system of the present invention as such members enjoy access to the greatest number and quality of leads possible. Preferably, the rating of member 10 will always be visible on the My Standing web page after a successful log-in so a sales person knows their status at all times.

The system monitors changes in status with Lead and Member Rating Control Engine 24 as leads are accessed and rated by others. If a status of member 10 changes from “Neutral” to “Good” for example, Lead and Member Rating Control Engine 24 will send a message to Communications Control Module 23 and an email will be sent to the member informing them of the change. Moves up in rating will be sent a positive, congratulations email and downgradings in status will be sent a cautionary note alerting them to the downgrade in status and privileges. The Lead and Member Rating Control Engine 24 will be accessed by Web Presentation GUI Engine 28 and will incorporate any changes in status in the My Standing page for that member the next time they log-in with a similar positive or negative message imbedded in the web page.

As these leads are accessed by other members of the present invention, they evaluate these leads after use based on the completeness and factualness of the leads. Evaluation of a lead by member 10 should not rate the lead based on whether that lead resulted in a sale or not. The terms and conditions of the system may clearly state that member 10 can only rate a lead based on the truthfulness and completeness of the data in a lead. If, for example, Mr. Jones is another “Neutral” rated member and uses his lead credits to “buy” Mr. Smith's lead, Mr. Jones will use the lead information to prospect into that customer. It may take a few weeks for Mr. Jones to determine if the lead was factually correct and complete. Mr. Jones may then provide a rating reflecting the veracity of the data regardless of whether or not a business transaction successfully occurred.

Preferably, the system will remind Mr. Jones on his “My Standing” web page (rendered after a successful log-in) that feedback is due on the lead. Also, Communications Control Module 23 may send out email reminders to rate the lead if Mr. Jones does not access his account for more than a set period of time.

If the lead Mr. Jones buys does indeed have correct and complete factual information Mr. Jones will rate the lead as a “Good” lead. His other options are to rate it “Neutral” or “Bad” if key sales information parameters are missing or data is flat out wrong. If he rates it “Good”, the lead rating score and the additional comments will stay with that lead, so other members 10 can also view the leads history, comments and rating before they decide if they want to buy that lead or not with their lead credits.

The rating score will accumulate on that lead along with the feedback of others that have accessed that lead. In the example provided, over time the lead will continue to build a rating for itself using the 1 to 4 rating scale. The more feedback over time, the more reliable that lead rating is. Members 10 that follow the terms and conditions will generally agree on the lead rating. Members 10 that do not follow the terms and conditions guidelines will typically be underrepresented in the ratings and their effect will be minimized due to others using the system properly.

Members 10 who deposit leads can rebut any feedback on a lead using a rating challenge method. All feedback as well as rebuttals are monitored by Lead and Member Rating Control Engine 24. Algorithms in the system will flag member 10 who owns the lead or those who leave feedback that is either consistently poor or that deviates significantly from other members submitting or rating a lead within the lead group. An examination of the significant deviators may be performed periodically. Warnings may be issued by an Arbitration Group to those who perpetually cause problems. After a number of warnings, if trouble behavior continues, a final warning may be issued. Any subsequent violation will result in termination of a member's ability to participate on the trade floor and may, at the discretion of an arbitrator, be asked to leave the repository as well and terminate their membership.

The same system may be used for rebutting the rating of member 10 which is the sum accumulation of their leads ratings. Members 10 wishing to refute their rating may do so to an arbitration group which will render a ruling on whether a member has been unfairly dealt with based on the terms and conditions of the system. They may intercede and refute a rating, leave it alone or terminate the membership of member 10 at their discretion within the terms and conditions of the system. In these situations human interaction is being used to insure proper operation of the software as well as to determine if individuals have been singled out for unfair treatment or whose rating integrity has been compromised in some unexpected fashion.

It is inevitable that people trading leads will encounter bad information in highly marked leads and therefore want their lead credits returned to them so they can buy another lead. The system may be programmed such that prior trading and return behaviors of members 10 on the trade floor will be monitored and subjected to an algorithm that will assess if the one that is returning a lead has done this before and therefore maybe a perpetual problem or if this is merely the occasional return of a lead. The algorithm preferably will also look at the other members 10 who have recently rated the lead and determine if they affirm or counter the “Bad” rating which may substantiate or refute the returning members claim. The algorithm will calculate a probability for crediting member 10 or not and either automatically issue a credit or deny the credit. Member 10 can accept or deny the judgment and/or appeal to customer service if dissatisfied with the algorithm's assessment.

Customer service will review the facts and act to either credit the account of member 10 or uphold the systems judgment. A notation will be placed in the member's record. Customer service has discretion to resolve the matter as they determine based on the circumstances as long as it complies with the general guidelines of the terms and conditions. Customer service will also manage any additional issues that come up related to payments, service cancellations, technical troubles with the system, etc.

In the example provided, as feedback accumulates on that lead as well as Mr. Smith's other leads, they in effect act to raise the overall rating of Mr. Smith, the depositor. This is called the “SalesElite Rating” or SER. It is a value for each member 10 based on overall rating based on the quality of their trading practices as well as their quantity of trades. This SER is used to gauge the trustworthiness of members 10 as well as their status. It is may also used by prospective employers when conducting a job search, which is discussed in more detail below.

In the example provided, if Mr. Smith's leads are indeed factually correct and are complete with required deep sales information, Mr. Smith's initial “Neutral” rating will begin to rise and he will eventually earn a “Good” rating. As Mr. Smith submits more leads, they will bear his new “Good” rating earning him 4 credits per submission versus the 2 credits he earned when he was rated as a “Neutral” making a lead submission. By earning a reputation as a “Good” member therefore has its rewards and pays itself back through wider lead access and higher credits per lead submission for use on the trade floor.

Conversely, if Mr. Smith was a “Neutral” rated member and the leads he submitted contained false or incomplete information, Mr. Smith's rating will fall as other members rate his leads “Bad”. Upon Mr. Smith falling into the “Bad” rating category, any new lead submissions will only earn him 1 lead credit and he will only be able to view and redeem his credits only for other “Bad” rated member's leads. “Good” and “Neutral” rated leads will not be accessible and may or may not be visible to Mr. Smith. Mr. Smith can redeem himself by being more diligent and begin to submit leads of higher quality and completeness. Mr. Smith can rise back up to the “Neutral” level and onto the “Good” level over time as rated by other members 10. Mr. Smith's history will always be known to other members 10 as this component helps buyers of leads know who they are dealing with. Behavior within the system over time is important as that helps to establish the true character of a salesperson and how they may operate in the real world. Member rating may be depicted using a graph with their member rating rising or falling on a 10 point scale over time.

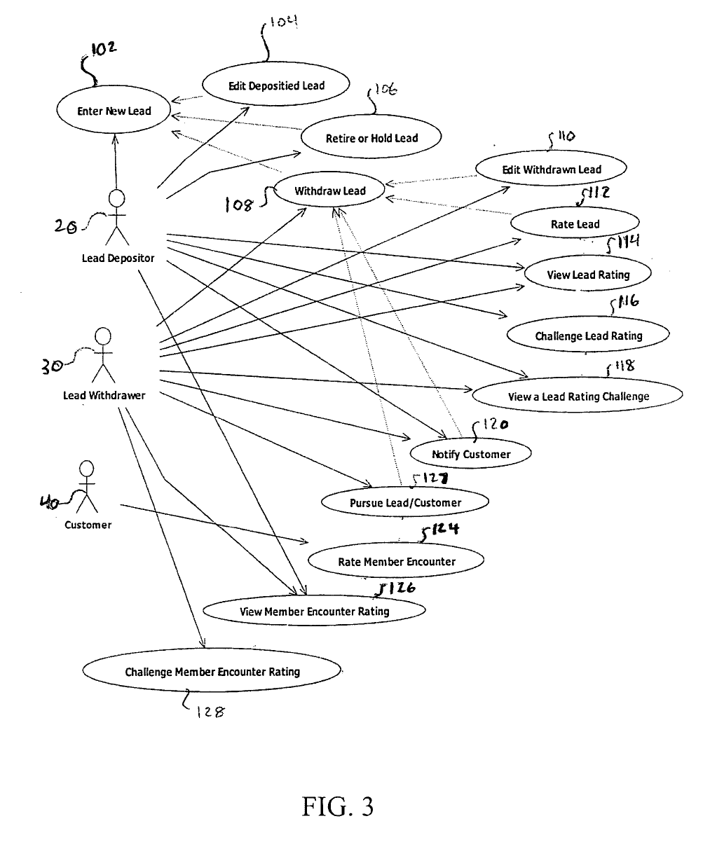

A lead transaction will now be discussed in more detail below. FIG. 3 is a flow chart illustrating the various steps associated with lead transactions. Involved in the lead transaction is lead depositor 20, who is a member of the system; lead withdrawer 30, who is also a member of the system, and customer 40, who is typically the subject of the lead.

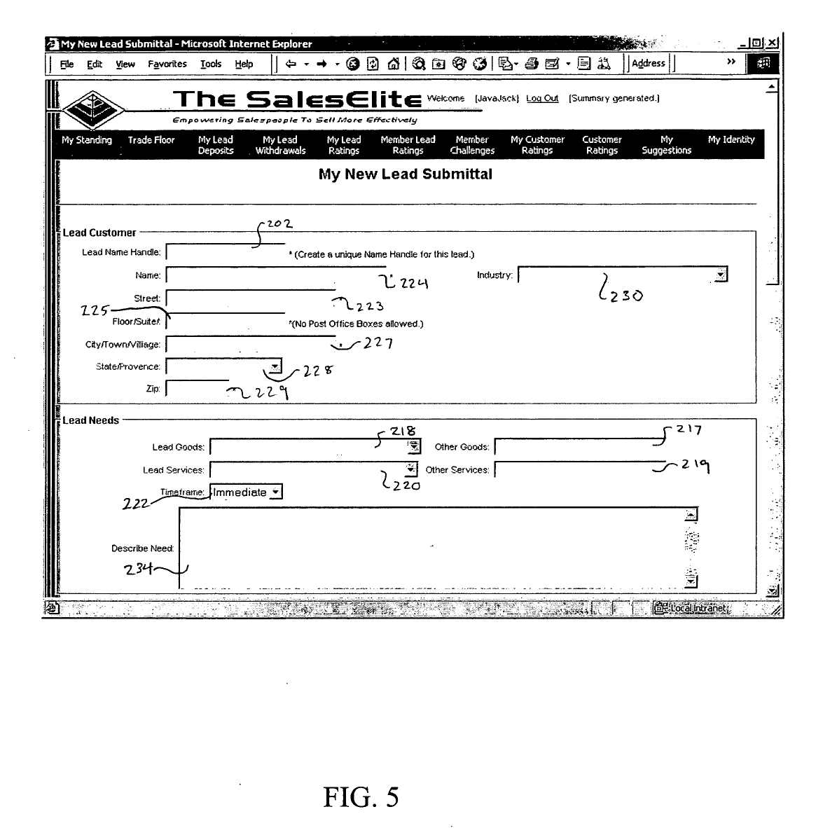

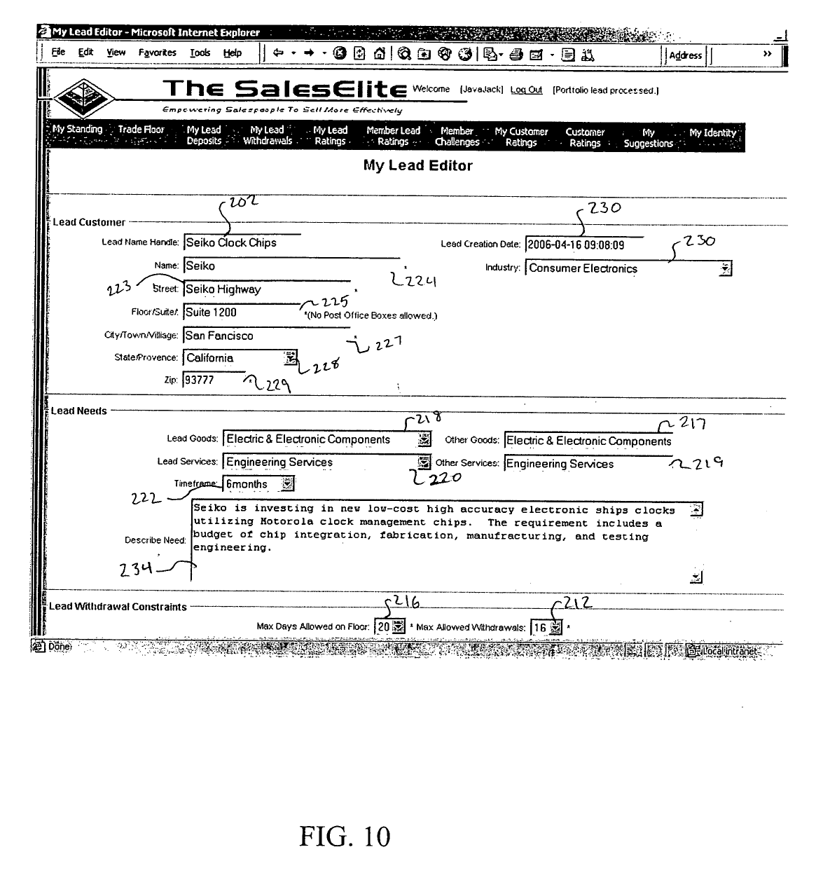

At step 102, lead depositor 20 enters a new lead into the system. The lead is entered through the usage of the form shown in FIGS. 5-7. FIG. 5 shows the various input areas through which depositor 20 enters information regarding the lead. FIG. 10 shows an example of a filled out version of this form that may be accessed through the editor function of the system. In lead name handle field 202 a name for the lead is created and chosen in order to identify the lead to members 10 who may wish to withdraw the lead. In the example shown in FIG. 10 the handle name selected is Seiko Clock Chips. The actual name of customer 40 is placed within name field 224. In the example shown in FIG. 10 the actual name of the company is Seiko. In industry field 230 the industry that the lead is part of is selected, consumer electronics is selected in FIG. 10. In street field 223 the street part of the address of customer 40 listed in name field 224 is provided. In Floor/suite field 225 the part of the address that corresponds to the floor or suite is provided if available. In City/Town/Village field 227 the city or town in which customer 40 resides is provided. In state/province field 228 the state or province in which customer 40 resides is provided. In zip field 229, the zip code of customer 40 is provided.

In addition to the basic information about the lead, the lead needs are entered as part of the lead information. In lead goods field 218 the goods with which customer 40 is associated is entered. In the example shown in FIG. 10 electric and electronic components is entered. In other goods field 217 any other goods that customer 40 is associated with is entered. In the example shown in FIG. 10 no other goods are associated with customer 40 so electric and electronic components is selected again. In lead services field 220 and other services field 219, any services associated with customer 40 are entered. In the example shown in FIG. 10, engineering services are entered. In timeframe field 222 the timeframe in which the lead is valid is provided. In need field 234 the actual need of customer 40 is listed. In the example shown in FIG. 10 the need is listed as “Seiko is investing in new low-cost high accuracy electronic ships clocks utilizing Motorola clock management chips. The requirement includes a budget of chip integration, fabrication, manufacturing, and testing engineering.”

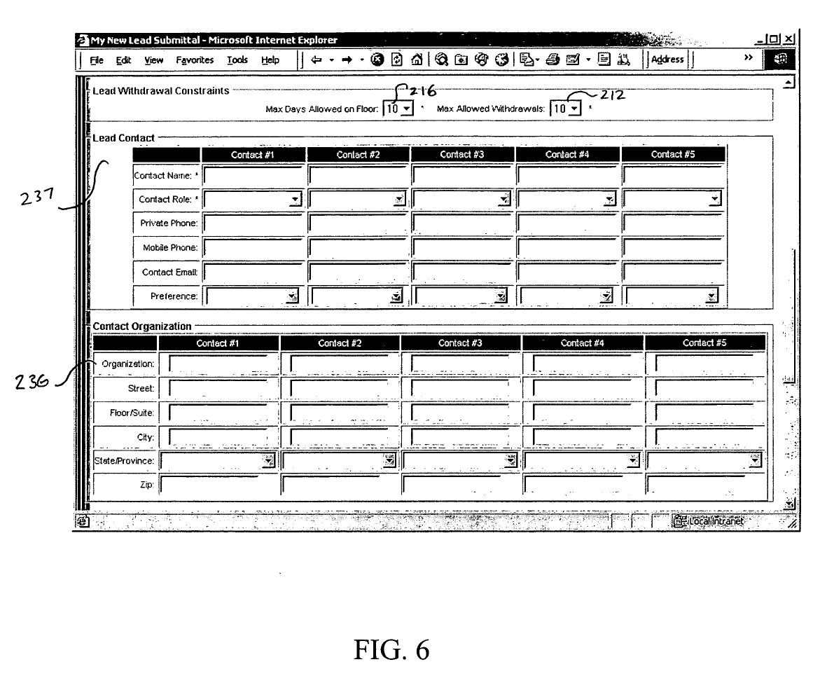

FIG. 6 contains further fields that will be entered with respect to the lead. Two additional fields are max trade days field 216 and max allowed withdrawals field 212. Max trade days field 216 sets out the maximum number days that a lead will be placed on the trade floor. Max allowed withdrawals field 212 sets out the maximum times that a lead can be taken from the trade floor. Whichever condition occurs first can remove a lead from the trade floor automatically. Additional sales lead protection fields not shown but that will be added in this area include the ability of the sales lead submitting member to prevent members within a particular vertical industry, that sell a particular good or service, members that presently work for or have worked in the past for a specific company (a potential competitor for example) or from within a specific geography from withdrawing a lead. These additional protection parameters will be added over time as well as a check off box to allow the submitting member to screen the profiles of each potential withdrawing member manually and either approving the withdrawal request or denying the withdrawal request based on their review of the information in that profile. This manual screening capability will utilize the Communications Control module and orchestrate each request as an email out to the submitting member with hyperlinks to the requesting member's profile data with a “Accept” or “Deny” button on the form for the submitting member to approve or deny this member's access to the requested sales lead. Lead contact field 237 provides the fields for entering the information related to whom to contact regarding the lead. Contact organization field 236 provides fields for entering information related to the organizations.

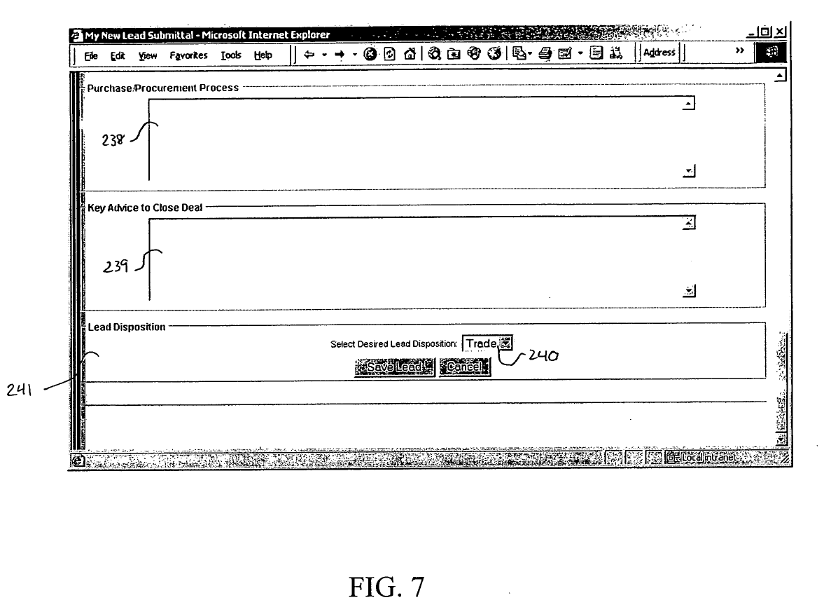

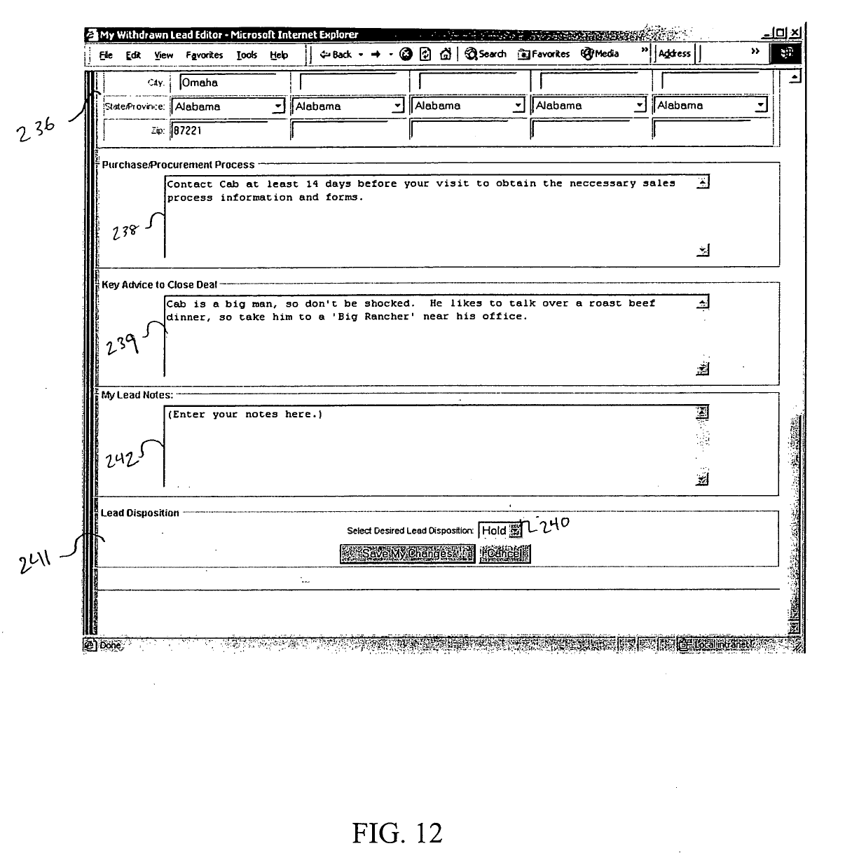

FIG. 7 contains further fields that may be entered with respect to the lead. Purchase/procurement field 238 provides purchase and procurement information related to the lead. FIG. 12 provides an example of purchase/procurement information in this case it is “Contact Cab at least 14 days before your visit to obtain the necessary sales process information and forms.” Key Advice field 239 is used to provide tips and advice regarding customer 40. In FIG. 12 an example of key advice is provided in key advice field 239, “Cab is a big man, so don't be shocked. He likes to talk over a roast beef dinner, so take him to a ‘Big Rancher’ near his office.” In lead disposition section 241 the status of the lead is chosen in desired lead disposition field 240 where depositor 20 opts to trade the lead. The lead is then validated and saved in database 12. The lead is then made visible on the trade floor.

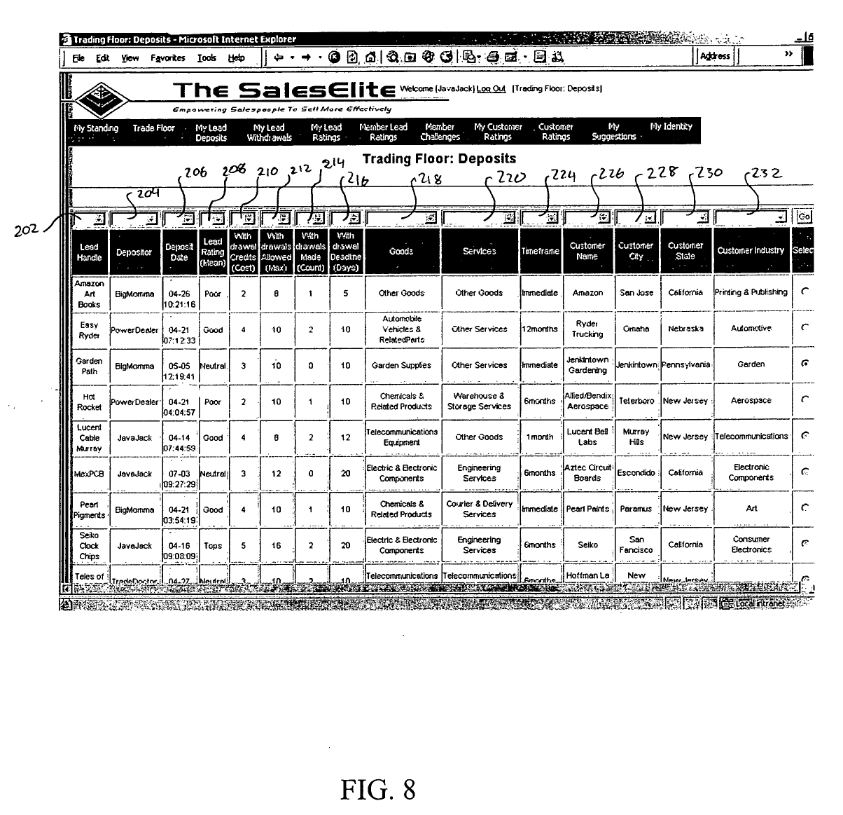

FIG. 8 shows an example of a deposit page of system when viewed by member 10. This page will list the lead that had been entered in step 102. In addition to the data that had been entered when initially entering lead information, there is trading information provided. In deposit date field 206 the date on which the lead was deposited is shown. In lead rating field 208 the rating of the lead is provided and shown. In withdrawal credits cost field 210 the cost of withdrawing the lead is shown. In withdrawals made field 214 the number of withdrawals made are listed. In withdrawal deadline field 216 the remaining number of days that the lead will be listed is shown. Select field 232 shows which lead is selected for further viewing.

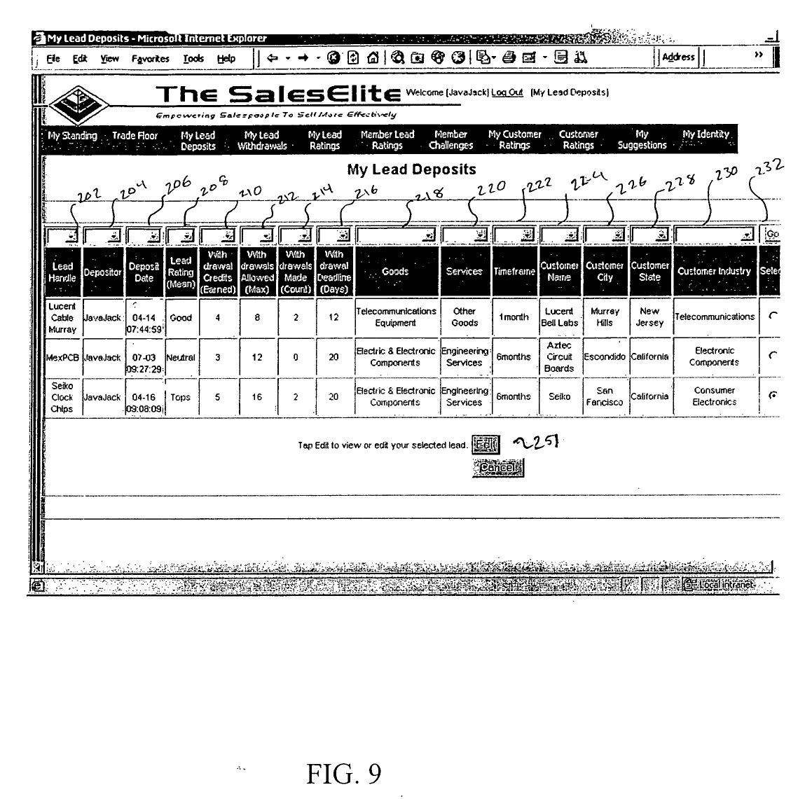

In step 104, of FIG. 3, the deposited lead may be edited by lead depositor 20. FIG. 9 shows a view of the page that lists all of the deposits. Depositor 20 can select to edit a lead by clicking on edit field 251. FIG. 10 shows the lead editor page, which contains all of the fields that depositor 20 would see when listing a new lead. Depositor 20 may edit the entered lead information in order to improve its contents or to update information. Changes to the entered lead information are not reflected in the content of previously withdrawn copies of this lead.

In step 106, lead depositor 20 may elect to retire or hold the lead, this removes the lead from the trading floor. This may be done in the event that some situation regarding the lead has changed. The system may keep track of early withdrawals and use that information in order to determine if depositor 20 frequently withdraws leads early. This may affect the overall rating of depositor 20.

In step 108, withdrawer 30 may withdraw from the trading floor the lead of depositor 20. The lead is not physically removed from the trade floor. Instead, a copy of the lead is created that becomes the property of withdrawer 30 and is saved to his or her portfolio. This allows the copied lead to be enhanced and edited by withdrawer 30 without affecting the content of the corresponding original deposited lead. The copied lead does not inherit enhancements (i.e., edits) to the corresponding original deposited lead. Copied leads, even if enhanced may not be electronically re-entered by the withdrawing member as a “new” lead at this time. ID tags embedded in the copied lead prevent the lead from being re-entered onto the trade floor for re-monitization by the withdrawing member. A member may break the ID tag trail by re-entering the information in the lead manually but this is expected to be a rare occurrence within the system.

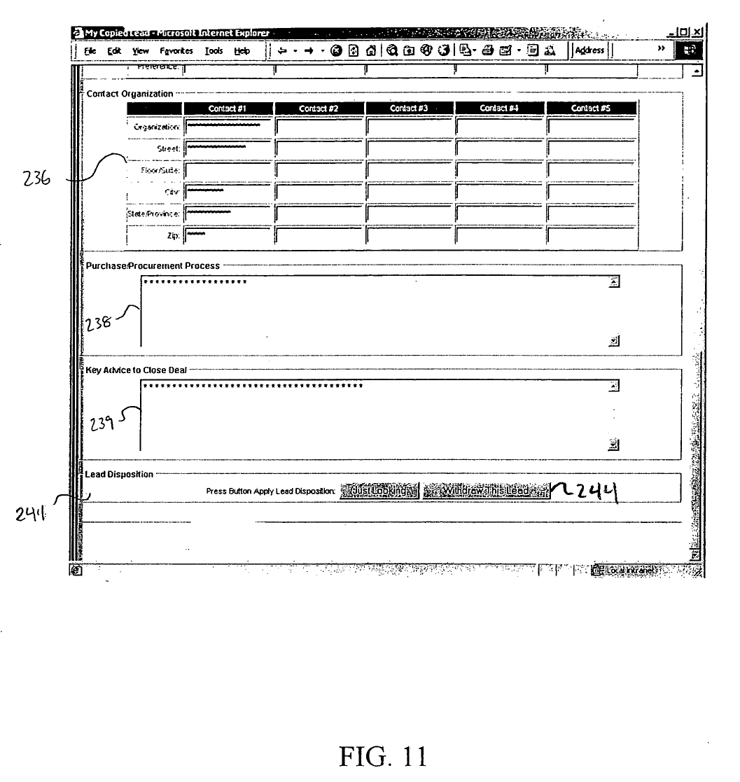

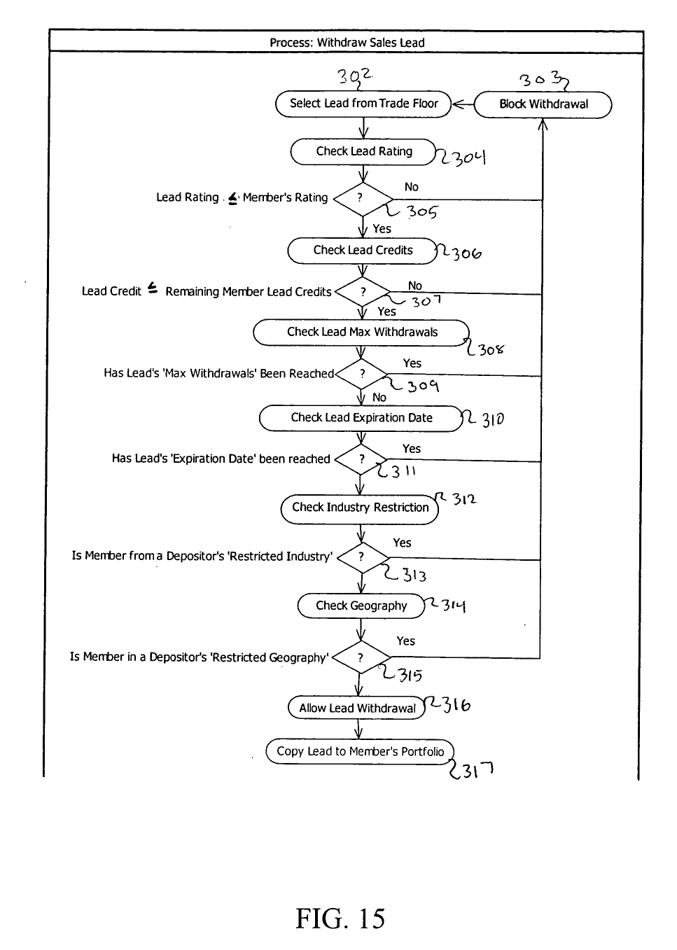

FIG. 11 shows a view of the lead details when initially selected. The information that is contained within the boxes is masked when potential withdrawer 30 is only browsing. When a potential withdrawer 30 is viewing a page he or she can select browsing option or withdrawal button 244 and indicate whether or not they are simply browsing or whether or not they actually intend to withdraw the lead. The process that the system uses in providing the withdrawal of leads is now discussed in detail with reference to FIG. 15. When a lead is fully withdrawn and paid for with sales lead credits, the masked information is replaced with the real information and this copied real lead information is what is deposited into the withdrawing members portfolio. The masked “*” are no longer blocking the data beneath.

FIG. 15 provides a logic diagram showing the lead withdrawal process in detail. In step 302 a lead is selected from the trade floor by withdrawer 30, who is a member 10 of the system. In step 304 the lead rating is checked by the system. In step 305 it is determined if the lead rating of the selected lead is less than or equal to the rating of member 10. If the lead rating is less than or equal to the rating of member 10 the process moves on to step 306, if not the withdrawal of the lead is blocked in step 303.

In step 306, the available credits of member 10 are checked by the system. In step 307 it is determined if the credits of member 10 are equal to or greater than the cost of the lead in credits. If enough credits are available the process moves on to step 308, if not the withdrawal of the lead is blocked in step 303.

In step 308, the maximum number of times that a particular lead can be withdrawn is checked. In step 309, the number of times that the lead has been withdrawn is checked, if the maximum number has been reached the withdrawal of that lead is blocked in step 303. If not the process will move onto step 310.

In step 310, the expiration date of the lead is checked. In step 311, it is determined if the expiration date of the lead has been reached, if it has been reached then the withdrawal of that lead is blocked in step 303. If not the process will move onto to step 312.

In step 312, the existence of industry restrictions will be checked. Industry restrictions may be placed upon a particular lead in order to prevent fruitless salesmanship or to prevent undesired competition. In step 313, it is determined if member 10 is from a restricted industry as established by depositor 20. Two additional steps not shown but intended to be added includes the screening of the withdrawing members present and past employers by company name against a “block company name” list preference set by the submitting member. Also, a submitting member may block a withdrawing member's specialty of selling a particular “good” or “service”. If member 10 is from a restricted industry, blocked company name or sells a particular blocked list or good or services, withdrawal of the lead is blocked in step 303. If not then the process will move onto step 314.

In step 314, the geographic location of member 10 is checked. In step 315, the system determines if that geographic location is part of the restricted list provided by depositor 20. If it is geographically restricted then the process will move onto step 316, if not the withdrawal of the lead will be blocked in step 303.

In step 316, the withdrawal of the lead is performed by the system and in step 317 a copy of the lead is provided to the portfolio of leads that member 10 will have. The logic enables depositor 20 to place a number of restrictions upon the withdrawal of a lead. It is possible to tailor restrictions to be limited to only select members, members who sell certain goods or services or people who are associated with a particular company. This provides an element of control for depositor 20 that ensures that helps in assuring that deposited information will not be used in a manner that negatively affects him or her.

Returning to FIG. 3, in step 110, withdrawer 30 may edit the withdrawn lead in order to either correct or improve its content, based on personal experience in using the lead to close deals. FIG. 12 illustrates a view of a page where withdrawer 30 can edit the lead. Lead notes field 242 is a field where withdrawer 30 may enter their own information.

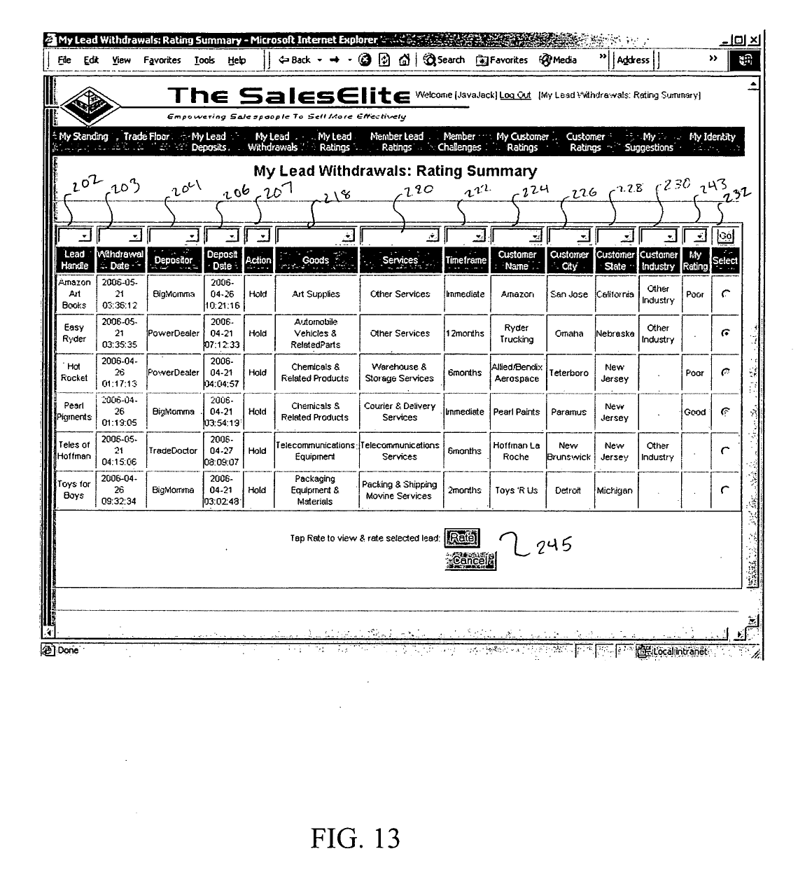

In step 112, withdrawer 30 may rate the withdrawn lead. This rating becomes permanently associated with the original deposited lead. FIG. 13 shows the page used for lead withdrawals. Withdrawal date field 203 displays the date that the lead was withdrawn by withdrawer 30. Action field 207 shows what action is currently being taken with respect to the listed lead. Rating display field 243 shows what rating withdrawer 30 had given to the lead. Rating box 245 is used by withdrawer 30 in order to pull up the rating screen where a withdrawing member can rate the lead.

In step 114, the lead rating may be viewed by depositor 20 in order to see how the lead has been perceived by the community. Depositor 20 may use this information in order to better prepare leads in the future. Withdrawer 30 may view the lead rating in order to get some information about the lead before withdrawing it from the trading floor.

After viewing the lead rating in step 114, in step 116 the lead rating may be challenged by depositor 20. Although the lead rating may be challenged, the rating should not be alterable at this point. The challenge of the lead rating may become a permanent attachment to the lead.

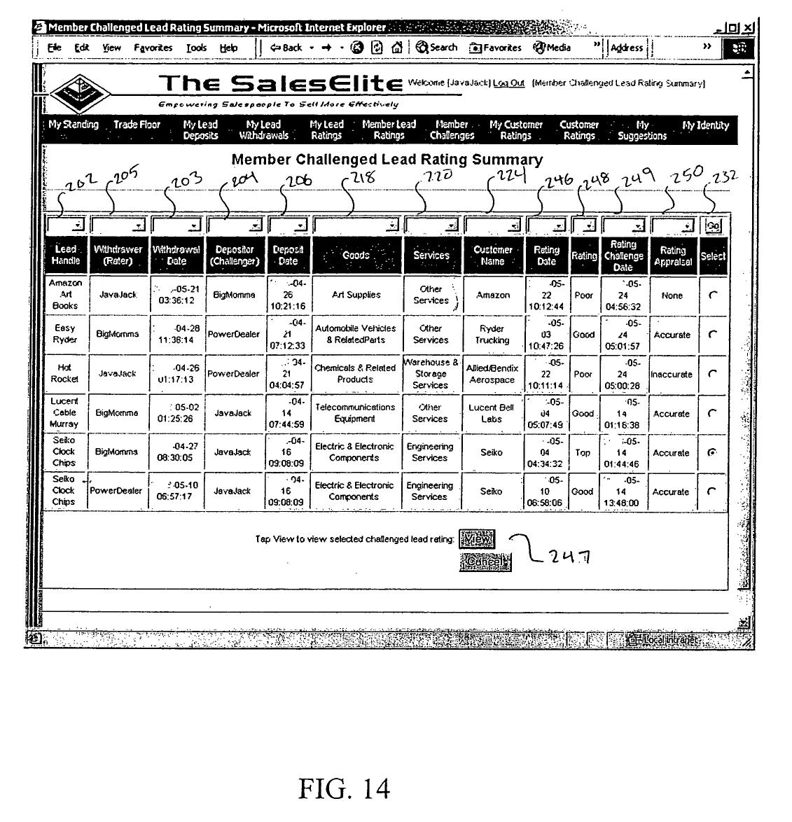

In step 118, withdrawer 30 may view the lead rating challenge. Withdrawer 30 may view this challenge regardless of whether or not he or she was the one who made the previous rating. This may be done in order to evaluate the merits of a previous rating and to view the response from depositor 20. FIG. 14 shows a view of the page that shows a listing of challenged lead ratings. In addition to those fields previously discussed above, the displayed page has additional fields. Withdrawer rater field 205 shows who the rater was for a particular lead. Rating date field 246 shows on what date a rating was made. Rating field 248 shows what the rating was. Rating challenge date field 249 shows on what date the rating was challenged. Rating appraisal field 250 shows how the rating has been viewed (e.g. accurate or inaccurate). Using challenge view button 247 the challenged lead can be viewed.

In step 120, customer 40 may be sent one of two emails to provide feedback on the submitting member as well as the withdrawing member. These emails are sent out at different times based on different events. These events include when a lead is originally deposited and the second after the lead is withdrawn by another withdrawing member. In the first case, the customer rates the salesmanship of the original lead submitter adding to the information and personal rating of the submitting member. In the second embodiment, an email is sent over 60 days after a lead is withdrawn by a member in order to solicit feedback from the customer about the withdrawing member's salesmanship who should have contacted them within that interval. The system will track any responses from the customer in the personal rating of the associated member. First, depositor 20 may specify that withdrawal of the lead will trigger a notification message be sent to customer 40. This may include a request for feedback from customer 40 such as the provision of a member encounter rating. The member encounter rating may then be applied to the member score card that feeds the overall score that one receives by the system (e.g. the SER). Second, withdrawer 30 may voluntarily issue a customer notification/feedback request at the time of the lead withdrawal. In either event, notification is sent to customer 40 via e-mail, or some other type of communication format. In the event that e-mail is used a CC to both depositor 20 and withdrawer 30 may be sent in the first case, or to only withdrawer 30, in the second case.

At step 122 withdrawer 30 should take the information found within the withdrawn lead and use it in order to try and achieve a sales goal. Based upon the steps taken by withdrawer 30 to contact customer 40 and the results of that encounter further feedback will then be provided back to the system. Contact with customer 40 and any resulting interaction may occur via any type of available communications.

At step 124 the member encounter is rated by customer 40 and/or withdrawer 30. The rating of the encounter may be given by only one party member or the rating may be an average of the two ratings provided by each member of the encounter. In the example shown in FIG. 3 the rating of the member encounter is provide by only customer 40.

At step 126, withdrawer 30 will view the member encounter rating that they received. Depositor 20 may also view the encounter rating. In step 128, withdrawer may disagree with the rating that was provided and issue a challenge. The challenge may be arbitrated in the manner discussed elsewhere.

Lead Exchange Accounting Module 21 will record the balance of the leads on the trade floor and maintain all transactions into and out of the system. Lead Exchange Accounting Module 21 accounts for all deposits to the trade floor, withdrawals from the trade floor and accrues lead interest for continued use of a lead by others. Lead interest is earned for each use of a lead. After each use, depositor 20 of that lead earns a lead credit based on the quality of that lead. If a depositor's rating is “Good” and they submit a lead into the trade floor, that lead acquires a rating of “Good” from depositor 20 at the time of deposit. Since the lead is rated “Good”, its earns its depositor 20 four lead credits. As this lead is accessed over time by other “Good” members operating on the trade floor and each member continues to rate the lead with a “Good” rating, after a number of uses, such as ten, the original depositor 20 will receive an additional 4 lead credits. If the lead continues to be used, for an additional number of uses, say another ten more times for a total of twenty uses and the rating is still high, depositor 20 earns another 4 credits or 12 credits in total for one “Good” lead submitted and so on. In this way, the user earns multiples on a “Good” lead over time. The same concept applies to “Neutral” and “Bad” rated leads except on their respective lead credit scales. The salesperson must therefore balance the potential for overuse of a lead rendering it less responsive over time and the earning of lead interest which adds monetization potential to the originally submitted or deposited lead.

Depositors 20 need to maintain their leads freshness over time to account for personnel changes at the sales lead or changes in management or structure that might turn a “Good” lead “Bad” over time. Depositors 20 therefore need to cull their leads, maintain them and retire them to prevent them being overused or made obsolete which may work against a one's rating. Active involvement in managing the leads is therefore essential to maximize one's use of the system.

An important aspect of the present invention is in earning the trust of members 10 to deposit and ultimately trade their prized, “off the grid” personal rolodex of sales leads. That trust is earned not only in the terms and conditions that bind both how the system of the present invention will operate but also how members 10 operate in order to create the proper positive repository and trading environments. Part of that trust involves the proper protection of leads submitted into the system, who can see and use those leads and insuring those leads do not get into untended hands. Privacy and Lead Protection Control Module 15 is designed to protect the privacy of a member based on their desired degree of anonymity or disclosure as well as the protections for their leads. Privacy Settings are established in the initial member profile. Member 10 can select to reveal none, some or all public profile parameters. These settings can be changed by the user overtime as well by accessing and logging into their member's only side of the system.

The valuable “off the grid” leads entered into the trading floor can be protected from viewing based on a series of parameters such as company name, industry, functional area, geographic area blocking, Sales Elite rating score, a specific member 10 or group of members 10 and several other parameters. For example the lead may be protected from being viewed by those in the north-east. Parameters may also be entered as conditional strings using Boolean operators such as “and”, “or”, “not”, “and not” or “near”. When putting protections on a sales lead, a balance between over protecting a lead and therefore forsaking earning lead interest versus under protecting and potentially being displaced by a competitor at a lead they were entrenched in, in the past. Members 10 need to understand the balance and manipulate settings accordingly. Lead protection settings may be accessed on the My Identity page or in the actual My New Lead Submittal page. These pages can be accessed in the member side of the system where member 10 has access to both their repository leads as well as trade floor leads. The settings for each lead are stored in the member info database and the Privacy and Lead Protection Control Module 15 controls the use of a lead by others based on the stored protection settings.

Through the course of use, members 10 may learn that other members 10 are consistent, fair and reliable and may be a strong ally to know over time. As a result, members 10 may seek to directly communicate with other members 10 without the structure of lead trading even though members 10 will likely want to continue using the trade floor due to the advantages of lead reciprocity and lead interest accumulation over time. This off the trade floor communication will be encouraged between members 10 but should adhere to all privacy control settings in the Privacy and Lead Protection Control Module 15.

In order for members 10 to get to know each other, they can submit a request to another member 10 to reveal themselves. When such a request is made, a link to the requesting party's profile is sent to the Communications Control Module 23 along with the requested member's unique User ID. The Communications Control Module 23 then does a reverse lookup on the requested party's User ID and pulls the requested member's email address from database 12. The Communications Control Module 23 generates an email containing the requesting member's link to the requesting party's profile along with a requesting member's personal message describing why they would like to communicate with that requested member 10. The requesting party never gets to see the requested member's email address. The requested member 10, upon receiving the email from the Communications Control Module 23 has the option to either accept the invitation in whole, in part or reject it. If accepted in whole, the Communications Control Module 23 sends an email back to the requesting party informing them that member 10 accepts the invitation and includes the requested member's profile link where their reach out name, address and phone number become available. If accepted in part, the requested member 10 can select what contact information they want sent to the requesting member 10. Some members 10 may want to only send them an email address, a phone number or a name. This is up to requested member 10 to decide. The SalesElite dimension of collaboration measures the willingness of a member to work with other members based on requests and acknowledgements. Each member gets to rate the other in terms of willingness to assist and collaborate upon request. This interaction is managed by the system using blind emails sent to members to evaluate other members. The emails capture simple ratings similar to the trustworthiness values used for correctness and completeness described elsewhere in this document. The ratings are also computed based on averages and all feedback is visible historically to be viewed by any member at anytime.

Finally, member 10 may reject a requesting member's request for communications and requesting member 10 is sent a brief note by Communications Control Module 23 to requesting member 10 stating a preference for anonymity and does not desire communication at this time. Requested members 10 may put blocks on communications requests globally or by specific individuals to avoid harassment situations. Communications Control Module 23 will monitor all requests and it will tally all requests by requesting member 10 to insure that requesting members 10 are not violating other member's rights to privacy. Requesting members 10 that attempt to violate or continue to request communications from members 10 that have rejected them twice in the past will be sent a warning and blocked from communicating again. Multiple violations over time will result in having member 10 expelled from the system.

The accumulated SalesElite Rating (SER) scorecard may carry three numeric values corresponding for all three measured dimensions of the SalesElite system, trustworthiness, salesmanship and collaboration. This scorecard in the system for a particular individual may be used by potential employers in the future for the purpose of extending interview and job offers for the best sales people. This SER may be a number between 1.0 and 10.0 for any of the three dimensions with 1.0 the lowest rating and 10.0 the highest possible rating. It is possible to provide other ratings type. In the example provided above, all new members enter the system with a 5.0 rating for “Neutral” for all three dimensions. “Bad” rated people are below 3.5 and “Good” rated people are above 6.5. The rating ascends or descends based on the completeness and truthfulness of the lead information, salesmanship and collaboration abilities. This SER scorecard can be used in order to gauge which individuals may be the best sales people to hire for a job as they have a track record that has been rated by their peers and customers over time. Potential hiring companies could expect a “Good” rated salesperson to not only manage their leads and their lead quality over time but also likely have a highly successful sales track record to match. Job search engine 17 may be used by prospective employers and members in order to locate each other. A prospective employer may search for a potential employee based upon their SER scorecard values. There may be a separate subscription service charging corporations for this capability as well as the right to send interview offers to members. Members in all circumstances remain anonymous to the would be corporate subscriber, choosing which offers to reject or accept and revealing their identity to the corporate subscriber at the time of the member's choosing.

Corporations may grant access to the system for a fee so that they can scan the system for sales people that meet their criteria, including but not limited to, average monetary sale size, geographic area, industry of focus, etc. Companies would not see the profiles of members 10, but would be able to select the likely ones they would want to communicate with. The company may then send a request to each member 10 asking them to reveal themselves to the company. The company would be able to send the targeted member 10 a message, which would include a job description and their desire to talk with them, etc. The message is handled identically as member 10 communications request described earlier. The company would also have a profile that they would fill out and it would be stored in a separate area of database 12. This company profile would be shared with member 10 so they can judge if the company is a good fit for their career. Each member 10 contacted by the company can either choose to fully accept, conditionally accept or reject a company's request to dialogue with them. All communications between the company and member 10 would be similar to the external communications between individuals.

Furthermore, a visitors pass may be created for members 10. This visitor pass will be used by members 10, allowing them to show either colleagues, headhunters or potentially hiring company's, the general size and scope of their entire lead base leads in their repository or leads on the trade floor without revealing any contact or company details about any one lead. This visitor pass allows member 10 to show what they bring to a potential employer in terms of leads or shows them validated data about their past sales. This helps to establish the credibility of member 10 in the eyes of a colleague, headhunter to potential hiring company. Visitor passes may cost a minor fee to member 10 and will expire based upon time had (Weeks, Days, Hours Minutes) or of times used (1 to 10 times accessible per discrete log-in on a Visitor Pass) delimited as specified by the member 10 when they purchase a visitor pass. Member 10 can either rely on the default mask of hidden values or customize showing more or less fields in their leads customized visitor pass filter mask.

Visitor passes will be managed by the Member Authentication Module 18 and a record of the visit will be posted to database 12. The visit will be visible from the account page. The visitor pass will be subject to the Privacy and Lead Protection Control module 15 where the visitor pass settings are stored. Fees for the visitor pass will be charged both to the member as well as to the company using the Billing System 22 and Payment Processing Engine 25.

As members 10 grow their repository lead base and their trade floor lead base over time, they create a powerful bargaining chip to get better jobs and to command a higher wage. Since the leads are in a common format and since the system of the present invention optionally has API's pre-built into its Import/Export API Utility 13. Members 10 may also sell their leads to companies or individuals as they contemplate a career change or possibly wish to cash out at retirement, or simply to make additional income. The present invention also provides a lead brokering service to help members 10 sell their leads in the open market. The operator's of the system will be compensated for this service by taking a percentage of the price of the leads sold by members 10. The exact percentage taken will depend upon what the market will bear, for example the percentage may be under 10%. In addition, the present invention will provide easy file format transfers for a fee so it can export sales leads from an individual and put them into a corporate CRM system, a standard contact software package like ACT™, Goldmine™or Outlook™ or into a generic comma delimited rich text format. The present invention will also supply a Professional Services Integration module should a purchasing company want exact data mapping of a salesperson's lead information into a Siebel™, SAP™, Oracle™ or other backend system.

The present invention provides a virtual community where sales oriented people can reap more rewards from their own personalized leads than any other organization available today. It standardizes the important parameters that are necessary to shorten sales cycles and provides a simple yet proven and effective way of determining which leads and salespeople are “Good”, which are “Bad” and which are “Neutral”.

Valuable “off the grid” leads (and associated deep sales knowledge) that are ripe for harvesting are important factors in the present invention. The present invention not only views salespeople as the target market, thereby looking at the group horizontally rather than vertically, but it also creates the correct “quid pro quo” so that salespeople can see value in entering and trading their leads in a virtual community of their peers. Thus, the present invention comprises a virtual community where salespeople can store, trade and communicate with other salespeople outside vertical corporate structures cheaply and freely. The salespeople can gain real value for their leads and participate in improving the overall sales process while making more money and improving their career opportunities along the way.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. An online sales lead information system, comprising:
a database of lead information;
a server operably connected to said database;
a router operably connected to said server; and
a lead rating control engine configured to provide a rating to said lead information.

2. The online sales leads information system of claim 1, wherein said database further contains member information.

3. The online sales leads information system of claim 2, wherein said lead rating control engine is further configured to provide a rating to a member.

4. The online sales lead information system of claim 3, further comprising a lead exchange accounting module, wherein said lead exchange accounting module prevents said member from withdrawing said lead information if said rating of said member is less than said rating of said lead information.

5. The online sales lead information system of claim 3, wherein said lead rating control engine correlates said rating of said lead information with said rating of said member.

6. The online sales lead information system of claim 1, further comprising a lead exchange accounting module.

7. The online sales lead information system of claim 6, wherein said lead exchange accounting module attributes interest credits to the lead information.

8. The online sales lead information system of claim 1, wherein said lead information is restricted from being traded by a member.

9. The online sales lead information system of claim 8, wherein said member restricts trading of said lead information based on a characteristic selected from the group consisting of industry and geography.

10. A method of providing sales lead information comprising the steps of:
providing to a database lead information, wherein the lead information is associated with a first member;
attributing a rating to the lead information; and
providing the lead information to a second member.

11. The method of claim 10, wherein an initial rating of said lead information is based upon a rating of said first member.

12. The method of claim 10, wherein a second member provides a rating for said lead information based upon accuracy of said lead information.

13. The method of claim 12, further comprising challenging said rating provided by said second member.

14. The method of claim 10, further comprising providing restrictions that prevent providing the lead information to said second member, wherein said restrictions are selected from the group consisting of industry and geography.

15. The method of claim 10, further comprising providing credit to said first member based upon the lead information.

16. The method of claim 15, wherein said credit comprises interest earned from said lead information, wherein said interest is earned.

17. The method of claim 10, wherein said second member has a rating that is greater than or equal to the rating attributed to said lead information.

18. The method of claim 10, wherein said second member meets a customer based upon said lead information.

19. The method of claim 18, wherein said customer provides a rating of said second member base upon said meeting.

20. An online sales lead information system comprising:
means for storing lead information;
means for providing a rating of said lead information, wherein said rating of said lead information is based upon a status of a first member.

21. The online sales lead information system of claim 20, further comprising means for preventing a second member from withdrawing said lead information if said rating of said second member is less than said rating of said lead information.

22. The online sales lead information system of claim 20, further comprising means for challenging a rating of said lead information.

23. The online sales lead information system of claim 20, further comprising accounting means for tracking credits spent in the system.

24. The online sales lead information system of claim 20, further comprising means for providing interest credits to said first member based upon use of said lead information.
